(19) United States
(12) Patent Application Publication
(10) Pub. No.: US 2011/0316758 A1
(43) Pub. Date: Dec. 29, 2011

(54) PORTABLE RADIO

(75) Inventors: Shingo Sumi, Miyagi (JP); Hiroaki Kobayashi, Ishikawa (JP); Toshihiro Asahina, Kanagawa (JP); Tsukasa Takahashi, Kanagawa (JP)

(73) Assignee: PANASONIC CORPORATION, Osaka (JP)

(21) Appl. No.: 13/203,749

(22) PCT Filed: Dec. 3, 2010
(86) PCT No.: PCT/JP2010/007070

§ 371 Date: Aug. 29, 2011

(30) Foreign Application Priority Data
Dec. 4, 2009 (JP) 2009-276560

(51) Int. Cl. H01Q 1/48

(52) U.S. Cl. 343/847

(57) ABSTRACT

An object of the present invention is to provide a portable radio apparatus that obtains a high antenna performance without limiting the degree of freedom in the exterior and design of a main body of portable radio apparatus. A portable radio apparatus (1) includes a radiation element (14) disposed on a side opposite to a rear part (10a) of a housing (10) through a circuit board (11), and a plate conductor (16) disposed substantially in parallel to the circuit board (11) between the circuit board (11) and the rear part (10a) of the housing (10). With the provision of the radiation element (14) and the plate conductor (16), when the portable radio apparatus (1) is put on a metal plate (300), the radiation element (14) operates as a vertical passive element having an electrical length of λ/2 with the help of an image current caused by the metal plate (300), and also the plate conductor (16) operates as a counterpoise of the radiation element (14), to thereby obtain a higher antenna performance on the metal plate (300). Also, since no rib for separating the antenna element (13) of the portable radio apparatus (1) from the metal plate is required, the degree of freedom in the exterior and design of the portable radio apparatus (1) main body is not limited.

### TECHNICAL FIELD

The present invention relates to a portable radio apparatus such as a cellular phone.

### BACKGROUND ART

As an antenna arrangement in a portable radio apparatus, a configuration is general in which an antenna element or a ground wire is arranged substantially in parallel to a longitudinal direction or a lateral direction of a housing of the portable radio apparatus. Incidentally, in this configuration, when it is assumed that the portable radio apparatus is put on a metal plate such as a metal desk, a positional relationship that the antenna element or the ground wire is close to and in parallel to the metal plate is frequently satisfied, resulting in such a problem that an antenna performance is remarkably deteriorated. A known proposal for solving the above problem is disclosed in, for example, Patent Documents 1 and 2.

Patent Document 1 discloses that a rib is provided on a part of a rear surface of a radio apparatus (portable radio apparatus) main body so that an antenna of the radio is spaced away from the metal plate when the radio is put on the metal plate. The antenna of the radio is spaced away from the metal plate by the rib disposed on the rear surface of the radio main body, thereby enabling the antenna performance to be deteriorated to obtain an excellent communication quality.

Patent Document 2 discloses that a radiation element is connected to a ground pattern of a circuit board connected with the antenna, and an auxiliary ground plane is coupled with the radiation element in a direction substantially perpendicular to the radiation element. FIG. 17 is a diagram illustrating a schematic configuration of a communication terminal disclosed in the document. A communication terminal 90 is a folding cellular phone including a lower housing 100 and an upper housing 200, and a lower board 101 is disposed in the lower housing 100 in parallel to a longitudinal direction thereof. A feed part 102 connected to a radio circuit (not shown) and an antenna element 103 connected to the feed part 102 are disposed on a right end of the lower board 101 in the figure. Also, a radiation element 104 extending vertically downward and an auxiliary ground plane 105 extending from a leading end of the radiation element 104 in parallel to the lower board 101 are disposed on a left end of the lower board 101 in the figure.

FIG. 18 is a diagram illustrating flows of an antenna current is and an image current ii when the communication terminal 90 is put on the metal plate 300. With the provision of the radiation element 104 and the auxiliary ground plane 105, when the communication terminal 90 is put on the metal plate 300 such as a metal desk, the radiation element 104 and the auxiliary ground plane 105 operate as a dipole antenna due to a mirror image effect (image) of the metal plate 300, thereby keeping an excellent receiving sensitivity of the communication terminal.

### Prior Art Document

Patent Document 1: JP-A-10-126304

Patent Document 2: JP-A-2007-329962

### SUMMARY OF THE INVENTION

### Problem to be Solved by the Invention

However, the conventional arts disclosed in the above-described Patent Documents 1 and 2 suffer from the following problems. In the technique disclosed in Patent Document 1, the exterior and design of the radio is affected by the rib provided on the radio main body, and the degree of freedom of the exterior and design is limited. Also, in the technique disclosed in Patent Document 2, because the auxiliary ground plane exclusively added functions as the ground per se, the radiation efficiency of the radiation element is not excellent, and the high antenna performance is not obtained.

The present invention has been made in view of the above circumstances, and aims at providing a portable radio apparatus that obtains the high antenna performance without limiting the degree of freedom in the exterior and design of the main body of the portable radio apparatus.

### Means for Solving the Problem

According to the present invention, there is provided a portable radio apparatus, including: a first housing; a circuit board disposed in the first housing and having a ground pattern with a distance to a rear part of the first housing, which is lower than ⅛ of a wavelength in an operating frequency band; a feed part connected to a radio circuit on the circuit board; an antenna element disposed at an upper rear part of the first housing and connected to the feed part; a first radiation element disposed on a side opposite to the rear part of the first housing through the circuit board; and a reactance element that connects one end of the first radiation element to the ground pattern.

According to the above configuration, when the portable radio apparatus is put on the metal plate such as the metal desk in a state where the portable radio apparatus is in operation, an image current having an opposite phase to that of the antenna current flows in the metal plate. The first radiation element operates as a vertical passive element having an electrical length of λ/2 due to a mirror image effect of the image current. As a result, the radiation efficiency of the first radiation element is enhanced to obtain the high antenna performance. Since the present invention requires no rib for separating the antenna element of the portable radio apparatus from the metal plate, the degree of freedom in the exterior and design of the main body of the portable radio apparatus is not limited.

According to the present invention, there is provided a portable radio apparatus, including: a first housing; a second housing coupled with the first housing; a circuit board disposed in the first housing and having a ground pattern with a distance to a rear part of the first housing, which is lower than ⅛ of a wavelength in an operating frequency band; a feed part connected to a radio circuit on the circuit board; an antenna element disposed at an upper rear part of the first housing and connected to the feed part; a first radiation element disposed on a side opposite to the rear part of the first housing through the circuit board; and a reactance element connecting one end of the first radiation element to the ground pattern.

According to the above configuration, the high antenna performance is obtained in the portable radio apparatus having two housings. Also, the degree of freedom in the exterior and design of the main body of the portable radio apparatus is not limited.

In the above configuration, there is provided a second radiation element disposed in the second housing, and the second radiation element and the first radiation element are connected to each other.

According to the above configuration, since the second radiation element is provided in addition to the first radiation element, the radiation efficiency is further enhanced to obtain the higher antenna performance.

In the above configuration, there is provided a housing coupling part that rotatably couples the first housing and the second housing, the housing coupling part includes a first coupling part and a second coupling part each made of an electrically conductive metal, the first coupling part and the second coupling part are high-frequency connected to each other and rotatably supported by each other, the first coupling part is provided on the first housing and electrically connected to the first radiation element, and the second coupling part is provided on the second housing and electrically connected to the second radiation element.

According to the above configuration, in the portable radio apparatus of a structure called “folding type”, the high antenna performance is obtained. Also, the degree of freedom in the exterior and design of the main body of the portable radio apparatus is not limited.

In the above configuration, the first coupling part and the first radiation element are connected to each other through the reactance element.

According to the above configuration, even if the electrical length of the second radiation element is changed, the second radiation element can resonate at the operating frequency band by adjusting a value of the reactance element. That is, the degree of freedom in the design of the second radiation element can been enhanced.

In the above configuration, there is provided a housing coupling part slidably coupling the first housing and the second housing, the housing coupling part includes a first coupling part and a second coupling part each made of an electrically conductive metal, the first coupling part and the second coupling part are high-frequency connected to each other and slidably supported by each other, the first coupling part is provided on the first housing and electrically connected to the first radiation element, and the second coupling part is provided on the second housing and electrically connected to the second radiation element.

According to the above configuration, in the portable radio apparatus of a structure called “slide type”, the high antenna performance is obtained. Also, the degree of freedom in the exterior and design of the main body of the portable radio apparatus is not limited.

In the above configuration, the first coupling part and the first radiation element are connected to each other through the reactance element.

According to the above configuration, even if the electrical length of the second radiation element is changed, the second radiation element can resonate at the operating frequency band by adjusting a value of the reactance element. That is, the degree of freedom in the design of the second radiation element can been enhanced.

In the above configuration, there is provided a plate conductor disposed substantially in parallel to the circuit board and disposed between the circuit board within the first housing and the rear part of the first housing, and the plate conductor and the ground pattern of the circuit board are connected to each other.

According to the above configuration, since the plate conductor operates as a counterpoise, and the ground is reinforced (radiation efficiency of the radiation element is enhanced), the higher antenna performance is obtained.

In the above configuration, the plate conductor and the ground pattern of the circuit board are connected to each other through the inductance element.

According to the above configuration, even if the size of the plate conductor is changed, the radiation element can easily resonate at the operating frequency band by adjusting a value of the inductance element. That is, the degree of freedom in the design of the radiation element can been enhanced.

### Advantages of the Invention

According to the present invention, in the portable radio apparatus such as the cellular phone, the higher antenna performance can be obtained with impairing the degree of freedom in the exterior and design of the main body of the portable radio apparatus.

### BRIEF DESCRIPTION OF THE DRAWINGS

FIG. 1 is a diagram illustrating a schematic configuration of an interior of a portable radio apparatus according to a first embodiment of the present invention.

FIG. 2 is a diagram illustrating flows of an antenna current and an image current when the portable radio apparatus of FIG. 1 is put on a metal plate.

FIG. 3 is a diagram illustrating a schematic configuration of an interior of a portable radio apparatus according to a second embodiment of the present invention.

FIG. 4 is a diagram illustrating open/close operation of the portable radio apparatus of FIG. 3.

FIG. 5 is a diagram illustrating flows of an antenna current and an image current when the portable radio apparatus of FIG. 3 is put on a metal plate.

FIGS. 6(a) and 6(b) are perspective views illustrating a first coupling part and the second coupling part of the portable radio apparatus of FIG. 3.

FIGS. 7(a) and 7(b) are perspective views illustrating states of a housing coupling part when the portable radio apparatus is closed and opened.

FIGS. 8(a) and 8(b) are an equivalent configuration diagram and an equivalent circuit diagram of the portable radio apparatus of FIG. 3.

FIG. 9 is a diagram illustrating a schematic configuration of an interior of a portable radio apparatus according to a third embodiment of the present invention.

FIG. 10 is a diagram illustrating a schematic configuration of an interior of one modified example of the portable radio apparatus of FIG. 9.

FIG. 11 is a diagram illustrating a schematic configuration of an interior of another modified example of the portable radio apparatus of FIG. 9.

FIG. 12 is a diagram illustrating a schematic configuration of an interior of still another modified example of the portable radio apparatus of FIG. 9.

FIG. 13 is a diagram illustrating a schematic configuration of an interior of a portable radio apparatus according to a fourth embodiment of the present invention.

FIG. 14 is a diagram illustrating the operation of opening the portable radio apparatus of FIG. 13.

FIGS. 15(a) and 15(b) are perspective views illustrating respective exteriors of a lower housing and an upper housing of the portable radio apparatus of FIG. 13.

FIG. 16 is a perspective view illustrating a housing coupling part of the portable radio apparatus of FIG. 13.

FIG. 17 is a diagram illustrating a schematic configuration of a conventional communication terminal.

FIG. 18 is a diagram illustrating flows of an antenna current and an image current when a communication terminal of FIG. 17 is put on a metal plate.

### MODES FOR CARRYING OUT THE INVENTION

Hereinafter, preferred embodiments for carrying out the invention will be described in detail with reference to the drawings.

### First Embodiment

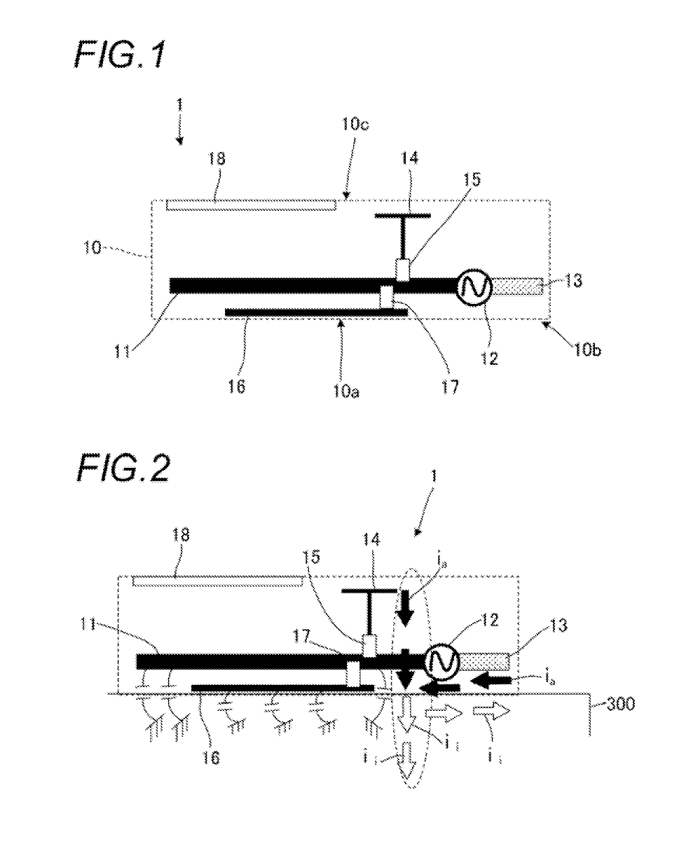

FIG. 1 is a diagram illustrating a schematic configuration of an interior of a portable radio apparatus according to a first embodiment of the present invention. In the figure, a portable radio apparatus 1 according to this embodiment includes one housing 10 (first housing) called “straight type”), a circuit board 11 having a ground pattern (not shown) with a distance to a rear part 10a of the housing 10, which is lower than ⅛ of a wavelength (λ) in an operating frequency band, and a feed part 12 connected to a radio circuit (not shown) on the circuit board 11. The portable radio apparatus 1 also includes an antenna element 13 disposed on an upper rear part 10b of the housing 10 and connected to the feed part 12, a radiation element (first radiation element) 14 disposed on a side opposite to the rear part 10a of the housing 10 through the circuit board 11, a reactance element 15 connecting one end of the radiation element 14 and the ground pattern of the radio circuit on the circuit board 11, and a plate conductor 16 disposed substantially in parallel to the circuit board 11 between the circuit board 11 and the rear part 10a of the housing 10 within the housing 10. The portable radio apparatus 1 further includes an inductance element (for example, coil) 17 connecting the plate conductor 16 and the ground pattern of the radio circuit on the circuit board 11, and a display part (for example, LCD (liquid crystal display)) 18 disposed on a front part 10c of the housing 10. The radiation element 14 has an electrical length set to about λ/4 including the reactance element 15.

FIG. 2 is a diagram illustrating flows of an antenna current and an image current when the portable radio apparatus 1 of this embodiment is put on a metal plate 300 such as a metal desk, and transmission is conducted by the antenna element 13. In the figure, when the portable radio apparatus 1 is put on the metal plate 300, the radiation element 14 operates as a passive element having an electrical length of λ/2 with the help of an image current I of the metal plate 300.

The plate conductor 16 operates as a counterpoise of the radiation element 14, and reinforces the ground. With the provision of the plate conductor 16, a radiation efficiency is further enhances as compared with that in the case of only the radiation element 14, thereby obtaining higher antenna performance. Incidentally, although the operating principle of the conventional art illustrated in FIG. 18 is similar to that of the present invention, because the radiation element 104 is arranged between the metal plate 300 and the circuit board 101, the precious circuit board 101 cannot be used as the ground of a vertical dipole antenna, and the auxiliary ground plane 105 is purposely added to configure the ground. For that reason, there is a tendency to weaken the ground of the vertical dipole, making it hard to get the higher antenna performance than that of the present invention.

The provision of the reactance element 15 enables the electrical length of the radiation element 14 to be adjusted whereby the degree of freedom in design of the radiation element 14 can be increased.

Thus, according to the portable radio apparatus 1 of this embodiment, there are provided the radiation element 14 disposed on a side opposite to the rear part 10a of the housing 10 through the circuit board 11, and a plate conductor 16 disposed substantially in parallel to the circuit board 11 between the circuit board 11 and the rear part 10a of the housing 10. When the portable radio apparatus 1 is put on the metal plate 300, the radiation element 14 operates as a vertical passive element having the electrical length of λ/2 with the help of the image current caused by the metal plate 300, and the plate conductor 16 operates as the counterpoise of the radiation element 14, thereby obtaining higher antenna performance.

The present invention requires no rib for separating the antenna element of the portable radio apparatus from the metal plate, and therefore does not limit the degree of freedom in the exterior and design of the main body of the portable radio apparatus 1.

### Second Embodiment

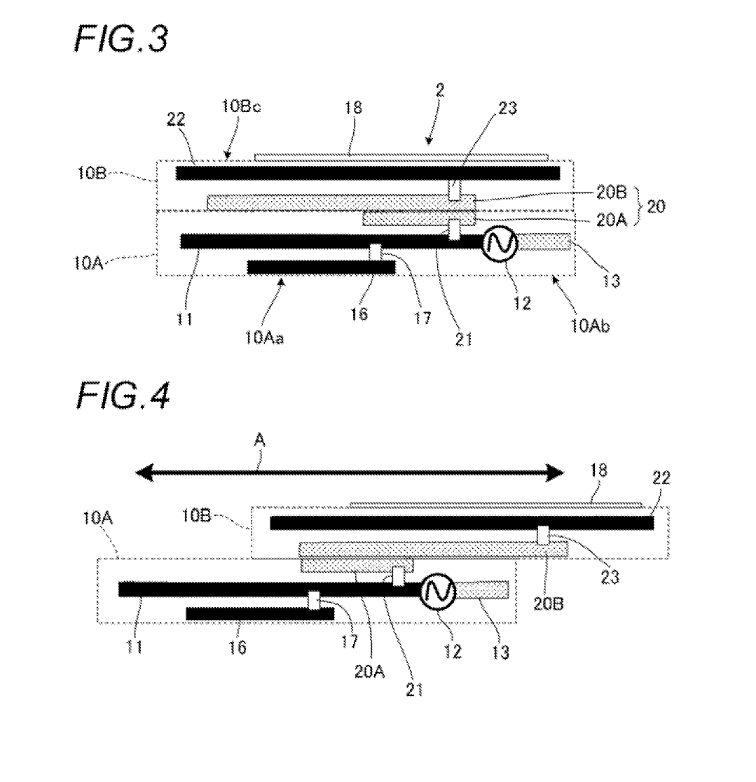

FIG. 3 is a diagram illustrating a schematic configuration of an interior of a portable radio apparatus according to a second embodiment of the present invention. In the figure, a portable radio apparatus 2 according to this embodiment is of a slide structure having a lower housing (first housing) 10A, an upper housing (second housing) 10B, and a housing coupling part 20 that slidably couples the lower housing 10A and the upper housing 10B together. The upper housing 10B is slid with respect to the lower housing 10A in a longitudinal direction of the housing (direction indicated by an arrow A of two ways in FIG. 4) so as to be openable and closable.

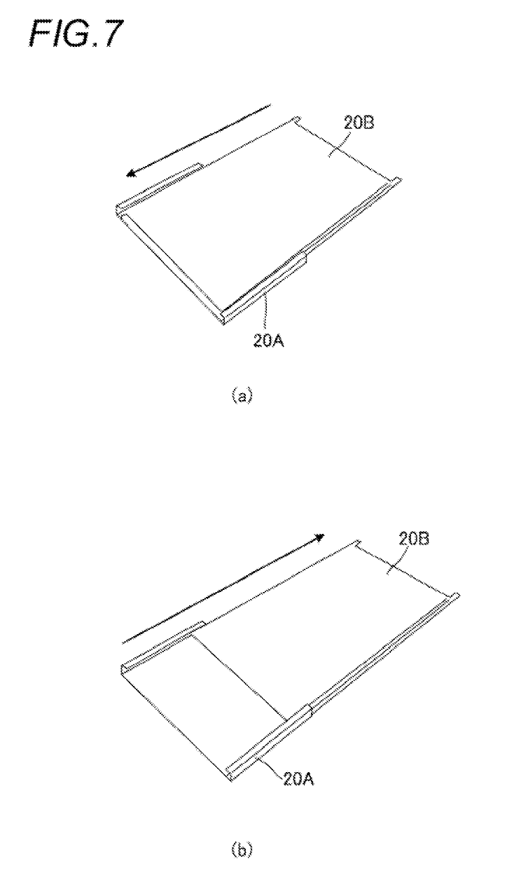

The housing coupling part 20 has a first coupling part 20A and a second coupling part 20B each made of electrically conductive metal. The first coupling part 20A and the second coupling part 20B are high-frequency coupled with each other, and slidably supported by each other. FIG. 6 is perspective views illustrating the first coupling part 20A and the second coupling part 20B, in which FIG. 6(a) is the second coupling part 20B, and FIG. 6(b) is the first coupling part 20A. Also, FIG. 7 is perspective views illustrating states of the housing coupling part 20 when the portable radio apparatus 2 is closed and opened, in which FIG. 7(a) illustrates the state of the housing coupling part 20 when the portable radio apparatus 2 is closed, and FIG. 7(b) illustrates the state of the housing coupling part 20 when the portable radio apparatus 2 is opened.

Returning to FIG. 3, the portable radio apparatus 2 according to this embodiment includes, at the lower housing 10A side, a circuit board (hereinafter referred to as “lower circuit board”) 11 having a ground pattern with a distance to a rear part 10Aa of the lower housing 10A, which is lower than ⅛ of a wavelength (λ), a feed part 12 connected to a radio circuit (not shown) on the lower circuit board 11, an antenna element 13 disposed on an upper rear part 10Ab of the lower housing 10A and connected to the feed part 12, a plate conductor 16 disposed substantially in parallel to the lower circuit board 11 between the lower circuit board 11 and the rear part 10Aa of the lower housing 10A, an inductance element 17 connecting the plate conductor 16 and the ground pattern of the radio circuit on the lower circuit board 11, and a reactance element 21 connecting the radio circuit on the lower circuit board 11 and the first coupling part 20A of the housing coupling part 20. Also, the portable radio apparatus 2 includes, at the upper housing 10B side, an upper circuit board 22 having a ground pattern, a reactance element 23 connecting the ground pattern of the upper circuit board 22 and the second coupling part 20B, and a display part 18 disposed on a front part 10Bc of the upper housing 10B.

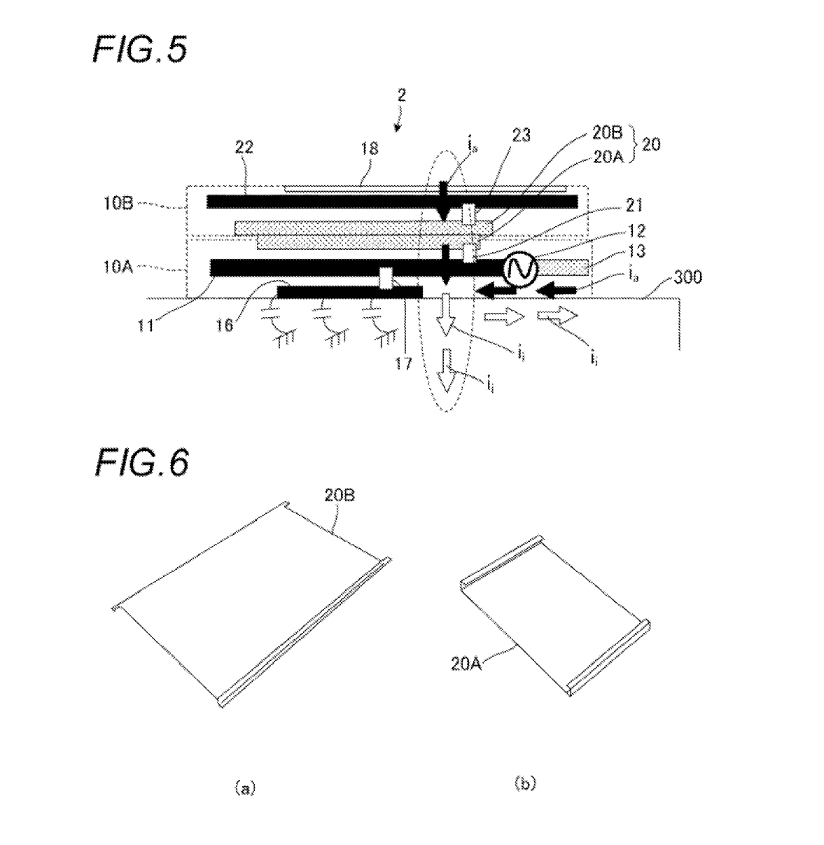

The upper circuit board 22 at the upper housing 10B side is formed with a ground pattern corresponding to the radiation element 14 of the portable radio apparatus 1 according to the above-mentioned first embodiment. That ground pattern serves as the radiation element, and is connected to the ground pattern of the circuit board 11 through the reactance element 23, the housing coupling part 20, and the reactance element 21. Also, the plate conductor 16 is connected to the ground pattern of the circuit board 11 through the inductance element 17, thereby obtaining the same advantage as that of the portable radio apparatus 1 according to the above-mentioned first embodiment. That is, as illustrated in FIG. 5, when the portable radio apparatus 2 is put on the metal plate 300, the housing coupling part 20 and the upper circuit board 22 operate as a passive element of λ/2 with the help of the image current caused by the metal plate 300, and also the plate conductor 16 operates as the counterpoise, thereby enhancing the radiation efficiency of the passive element to obtain higher antenna performance.

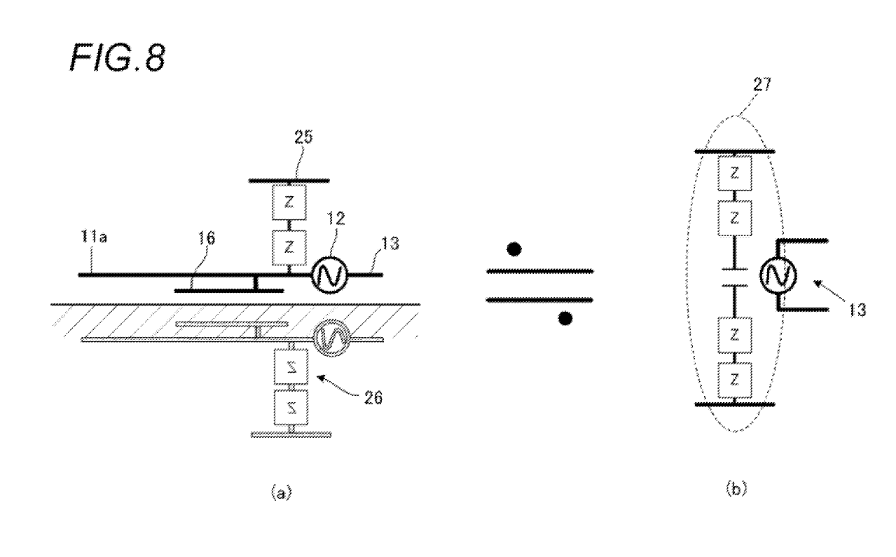

FIG. 8(a) is an equivalent configuration diagram of the portable radio apparatus 2 according to this embodiment. In the figure, reference symbol 11a represents a ground pattern of the lower circuit board 11. Reference numeral 25 represents a radiation element derived from the ground pattern of the upper circuit board 22, and having an electrical length of λ/4. Reference numeral 26 represents an image. FIG. 8(a) can be replaced with an equivalent circuit of FIG. 8(b). The radiation element operates as a passive element 27 of λ/2 together with the image side.

The housing coupling part used for the slide type portable radio apparatus is formed of a large-sized conductor, and also arranged at a position not overlapping with the antenna element in a thickness direction, and therefore the passive element of λ/2 is easily configured by the existing parts. Also, the portable radio apparatus is of a structure in which the LCD (display part 18) can be always viewed by open/close of the housing, and when the portable radio apparatus is put on the metal plate, the LCD is situated on an upper side, and the lower housing is situated on the metal plate side. Therefore, the slide type portable radio apparatus is particularly suitable for the present invention.

Also, with the provision of the reactance elements 21 and 23, the electrical length of the ground pattern of the upper circuit board 22 as the radiation element can be adjusted. That is, the degree of freedom in the design of the ground pattern can be enhanced.

Thus, also in the portable radio apparatus 2 according to this embodiment, the higher antenna performance is obtained with the provision of the portable radio apparatus on the metal plate 300. Also, as in the first embodiment, the degree of freedom in the external and design of the main body of the portable radio apparatus 2 is not limited.

### Third Embodiment

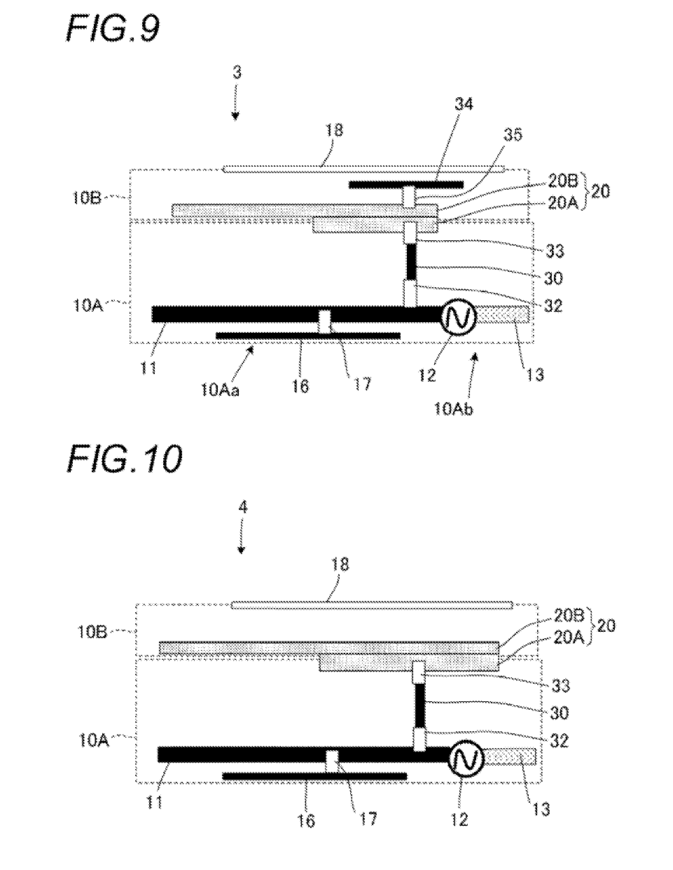

FIG. 9 is a diagram illustrating a schematic configuration of an interior of a portable radio apparatus according to a third embodiment of the present invention. In the figure, a portable radio apparatus 3 according to this embodiment is of a structure called “slide type” as with the portable radio apparatus 2 of the above-mentioned second embodiment. The portable radio apparatus 3 includes a lower housing (first housing) 10A, an upper housing (second housing) 10B, and a housing coupling part 20 that slidably couples the lower housing 10A and the upper housing 10B together. The housing coupling part 20 includes a first coupling part 20A disposed in the lower housing 10A, and a second coupling part 20B disposed in the upper housing 10B.

The portable radio apparatus 2 includes, at the lower housing 10A side, a circuit board 11 having a ground pattern with a distance to a rear part 10Aa of the lower housing 10A, which is lower than λ/8, a feed part 12 connected to a radio circuit (not shown) on the circuit board 11, an antenna element 13 disposed on a rear part 10Ab of the lower housing 10A and connected to the feed part 12, a first radiation element 30 disposed at a side opposite to the rear part 10Aa of the lower housing 10A through the circuit board 11, and a reactance element 32 connecting one end of the first radiation element 30 to the ground pattern of the radio circuit on the circuit board 11. Also, the portable radio apparatus 2 includes, at the lower housing 10A side, a reactance element 33 connecting the other end of the first radiation element 30 to the first coupling part 20A of the housing coupling part 20, and a plate conductor 16 disposed substantially in parallel to the circuit board 11 between the circuit board 11 and the rear part 10Aa of the lower housing 10A. Also, the portable radio apparatus 2 includes, at the upper housing 10B side, a second radiation element 34 disposed substantially in parallel to the display part 18 between the second coupling part 20B of the housing coupling part 20 and the display part 18, and a reactance element 35 connecting the second radiation element 34 to the second coupling part 20B of the housing coupling part 20.

In the portable radio apparatus 3 according to this embodiment, the electrical lengths of the first radiation element 30, the housing coupling part 20, and the second radiation element 34 are set to about λ/4 including the reactance elements 32, 33, and 35. When the portable radio apparatus 3 is put on the metal plate 300 as illustrated in FIG. 2, each element operates as a passive element of λ/2 with the help of the image current caused by the metal plate 300. Further, since the plate conductor 16 operates as the counterpoise, the radiation efficiency of the passive element is enhanced to obtain the higher antenna performance.

With the provision of the reactance elements 32, 33, and 35, the electrical lengths of the first radiation element 30 and the second radiation element 34 can be adjusted. That is, the degree of freedom in the design of the first radiation element 30 and the second radiation element 34 can be enhanced.

Thus, also in the portable radio apparatus 3 according to the third embodiment, the higher antenna performance is obtained with the provision of the portable radio apparatus on the metal plate 300. Also, as in the first embodiment, the degree of freedom in the external and design of the main body of the portable radio apparatus 3 is not limited.

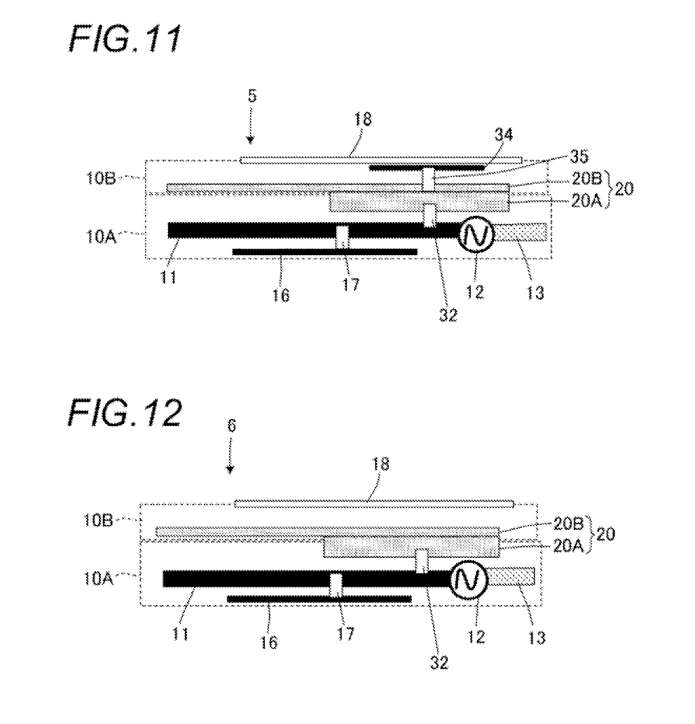

Modified examples of the portable radio apparatus 3 according to this embodiment are illustrated in FIGS. 10 to 12. A portable radio apparatus 4 illustrated in FIG. 10 is provided with only the first radiation element 30. A portable radio apparatus 5 illustrated in FIG. 11 is provided with only the second radiation element 34. A portable radio apparatus 6 illustrated in FIG. 12 is provided with no radiation element at all, and uses the housing coupling part 20 instead of the radiation element. All of those examples can obtain the same advantages as those in the portable radio apparatus 3.

### Fourth Embodiment

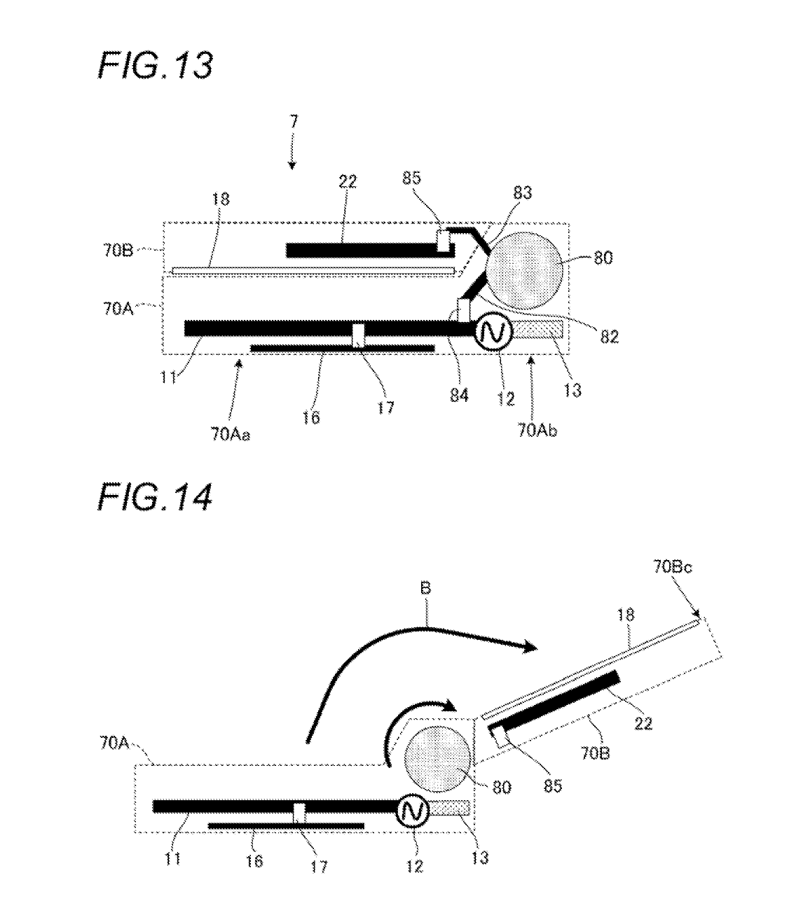

FIG. 13 is a diagram illustrating a schematic configuration of an interior of a portable radio apparatus according to a fourth embodiment of the present invention. In the figure, a portable radio apparatus 7 according to this embodiment is of a folding structure including a lower housing (first housing) 70A, an upper housing (second housing) 70B, and a housing coupling part 80 that rotatably couples the lower housing 70A and the upper housing 70B together. The portable radio apparatus 7 can be opened by rotating the upper housing 70B in a direction indicated by an arrow B in FIG. 14, and can be closed by rotation in a reverse direction.

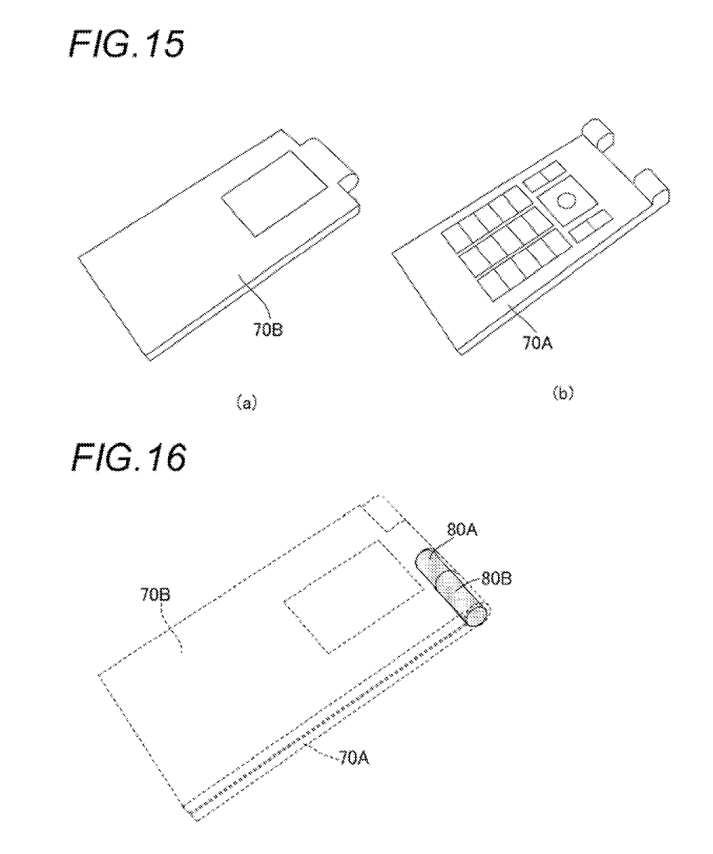

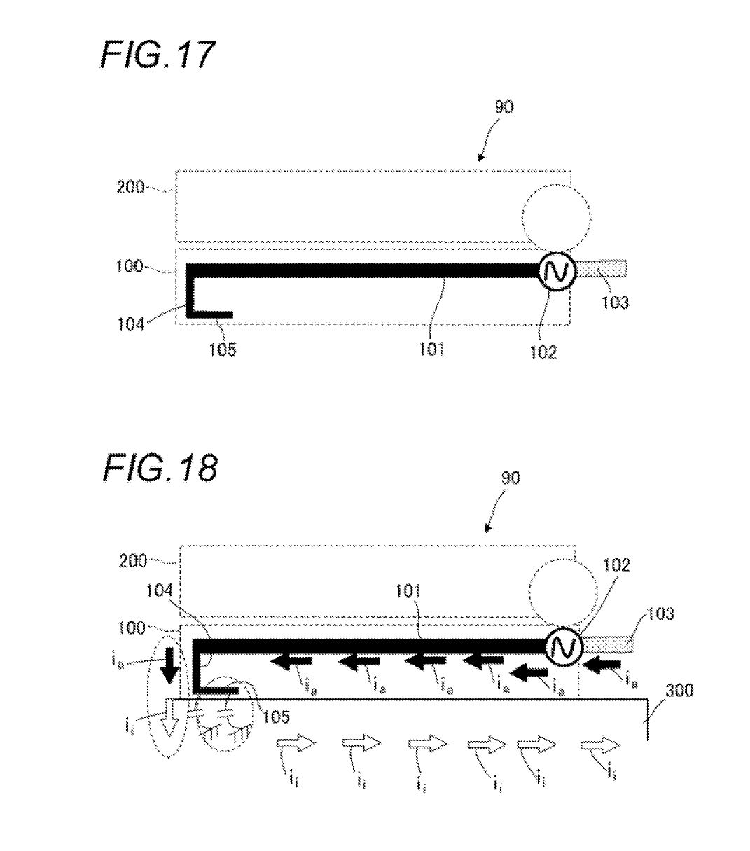

FIG. 15 is perspective views illustrating respective exteriors of the lower housing 70A and the upper housing 70B, in which FIG. 15(a) is the upper housing 70B and FIG. 15(b) is the lower housing 70A. FIG. 16 is a perspective view illustrating the housing coupling part 80 connecting the lower housing 70A and the upper housing 70B. The housing coupling part 80 includes a first coupling part 80A and a second coupling part 80B each made of electrically conductive metal. The first coupling part 80A and the second coupling part 80B are high-frequency coupled with each other, and rotatably supported by each other. The first coupling part 80A is disposed in the lower housing 70A, and electrically connected to a first radiation element 82. The second coupling part 80B is disposed in the upper housing 70B, and electrically connected to a second radiation element 83.

The portable radio apparatus 7 includes, at the lower housing 70A, a circuit board (hereinafter referred to as “lower circuit board”) 11 having a ground pattern with a distance to a rear part 10Aa of the lower housing 10A, which is lower than λ/8, a feed part 12 connected to a radio circuit (not shown) on the lower circuit board 11, and an antenna element 13 disposed on an upper rear part 70Ab of the lower housing 70A and connected to the feed part 12. The portable radio apparatus 7 also includes, at the lower housing 70A, a plate conductor 16 disposed substantially in parallel to the lower circuit board 11 between the lower circuit board 11 and the rear part 70A of the lower housing 70A, a reactance element 17 connecting the plate conductor 16 and the ground pattern of the circuit board 11, and a reactance element 84 connecting the ground pattern of the circuit board 11 and the first coupling part 80A of the housing coupling part 80. Further, the portable radio apparatus 7 includes, at the upper housing 70B, an upper circuit board 22 having a ground pattern, a reactance element 85 connecting the ground pattern of the upper circuit board 22 and the second coupling part 80B of the housing coupling part 80, and a display part 18 disposed on a front part 70Bc of the upper housing 70B (refer to FIG. 14).

In the portable radio apparatus 7 according to this embodiment, the electrical lengths of the first radiation element 82, the housing coupling part 80, and the second radiation element 83 are set to about λ/4 including the reactance elements 84 and 85. When the portable radio apparatus 7 is put on the metal plate 300 as illustrated in FIG. 2, each element operates as a passive element of λ/2 with the help of the image current caused by the metal plate 300. Further, since the plate conductor 16 operates as the counterpoise, the radiation efficiency of the passive element is enhanced to obtain the higher antenna performance.

With the provision of the reactance elements 84 and 35, the electrical lengths of the first radiation element 82 and the second radiation element 83 can be adjusted, and the degree of freedom in the design of the first radiation element 82 and the second radiation element 83 can be enhanced.

Thus, also in the portable radio apparatus 7 according to the fourth embodiment, the higher antenna performance is obtained with the provision of the portable radio apparatus on the metal plate 300. Also, as in the first embodiment, the degree of freedom in the external and design of the main body of the portable radio apparatus 7 is not limited.

The present invention has been described in detail and with reference to specific embodiments. However, it would be obvious by an ordinary skilled person that various modifications and corrections can be made without departure from the spirit and scope of the present invention.

The present invention is based on Japanese Patent Application No. 2009-276560 filed on Dec. 4, 2009, and the contents of which are incorporated herein by reference.

### INDUSTRIAL APPLICABILITY

The present invention has such advantages that the high antenna performance can be obtained without limit of the degree of freedom in the exterior and design of the main body of the portable radio apparatus, and can be applied to the portable radio apparatuses such as cellular phones.

### Description of Symbols

1 to 7, portable radio apparatus

10, housing

10A, lower housing

10B, upper housing

10a, 10Aa, and 70Aa, rear part

10c and 10Bc, front part

11, circuit board

11a, ground pattern

12, feed part

13, antenna element

14 and 25, radiation element

15, 21, 23, 32, 33, 35, 84, and 85, reactance elements

16, plate conductor

17, inductance element

18, display part

20 and 80, housing coupling part

20A and 80A, first coupling part

20B and 80B, second coupling part

26, image

27, passive element

30 and 82, first radiation element

34 and 83, second radiation element

300, metal plate

1. A portable radio apparatus, comprising:
a first housing;
a circuit board disposed in the first housing and having a ground pattern with a distance to a rear part of the first housing, which is lower than ⅛ of a wavelength in an operating frequency band;
a feed part connected to a radio circuit on the circuit board;
an antenna element disposed at an upper rear part of the first housing and connected to the feed part;
a first radiation element disposed on a side opposite to the rear part of the first housing through the circuit board; and
a reactance element that connects one end of the first radiation element to the ground pattern.

2. A portable radio apparatus, comprising:
a first housing;
a second housing coupled with the first housing;
a circuit board disposed in the first housing and having a ground pattern with a distance to a rear part of the first housing, which is lower than ⅛ of a wavelength in an operating frequency band;
a feed part connected to a radio circuit on the circuit board;
an antenna element disposed at an upper rear part of the first housing and connected to the feed part;
a first radiation element disposed on a side opposite to the rear part of the first housing through the circuit board; and
a reactance element connecting one end of the first radiation element to the ground pattern.

3. The portable radio apparatus according to claim 2, further comprising:
a second radiation element disposed in the second housing,
wherein the second radiation element and the first radiation element are connected to each other.

4. The portable radio apparatus according to claim 3, further comprising:
a housing coupling part that rotatably couples the first housing and the second housing,
wherein the housing coupling part includes a first coupling part and a second coupling part each made of an electrically conductive metal, and the first coupling part and the second coupling part are high-frequency connected to each other and rotatably supported by each other;
wherein the first coupling part provided on the first housing and electrically connected to the first radiation element; and
wherein the second coupling part is provided on the second housing and electrically connected to the second radiation element.

5. The portable radio apparatus according to claim 4, wherein the first coupling part and the first radiation element are connected to each other through the reactance element.

6. The portable radio apparatus according to claim 3, further comprising:
a housing coupling part slidably coupling the first housing and the second housing,
wherein the housing coupling part includes a first coupling part and a second coupling part each made of an electrically conductive metal, and the first coupling part and the second coupling part are high-frequency connected to each other and slidably supported by each other;
wherein the first coupling part is provided on the first housing and electrically connected to the first radiation element; and
wherein the second coupling part is provided on the second housing and electrically connected to the second radiation element.

7. The portable radio apparatus according to claim 6, wherein the first coupling part and the first radiation element are connected to each other through the reactance element.

8. The portable radio apparatus according to claim 1, further comprising:
a plate conductor disposed substantially in parallel to the circuit board and disposed between the circuit board within the first housing and the rear part of the first housing,
wherein the plate conductor and the ground pattern of the circuit board are connected to each other.

9. The portable radio apparatus according to claim 8, wherein the plate conductor and the ground pattern of the circuit board are connected to each other through the inductance element.

10. The portable radio apparatus according to claim 2, further comprising:
a plate conductor disposed substantially in parallel to the circuit board and disposed between the circuit board within the first housing and the rear part of the first housing,
wherein the plate conductor and the ground pattern of the circuit board are connected to each other.

11. The portable radio apparatus according to claim 10, wherein the plate conductor and the ground pattern of the circuit board are connected to each other through the inductance element.
